(19) United States
(12) Patent Application Publication
(10) Pub. No.: US 2013/0198152 A1
(43) Pub. Date: Aug. 1, 2013

(54) SYSTEMS AND METHODS FOR DATA COMPRESSION

(71) Applicants: Lashawn McGhee, Murrieta, CA (US); Giovanni Motta, San Diego, CA (US); Marko Slyz, San Diego, CA (US)

(72) Inventors: Lashawn McGhee, Murrieta, CA (US); Giovanni Motta, San Diego, CA (US); Marko Slyz, San Diego, CA (US)

(21) Appl. No.: 13/819,334

(22) PCT Filed: Sep. 10, 2010
(86) PCT No.: PCT/US10/48437

§ 371 Date: Feb. 26, 2013

(51) Int. Cl. G06F 17/30

(52) U.S. Cl. CPC G06F 17/30303
USPC 707/693

(57) ABSTRACT

In one example embodiment, an updated version of a file is encoded via differential encoding from an original version of the file (50). A portion of the updated version of the file is selected and matched with at least one portion of the original version of the file (54). At least one dictionary entry is created in a dictionary associated with the differential encoding according to the matched at least one portion of the original version of the file (56).

### BACKGROUND

Data compression is the process of transforming information from one representation to another, more compact representation from which the original can be recovered. The compression and decompression processes are often referred to as encoding and decoding, respectively, Data compression has applications in the areas of data storage and data transmission. Besides compression savings, other parameters of concern include encoding and decoding speeds and workspace requirements, the ability to access and decode partial flies, and error resilience.

### BRIEF DESCRIPTION OF THE DRAWINGS

FIG. 1 illustrates an example embodiment of a mobile communications system.

FIG. 2 illustrates an example method for compressing a file via differential encoding.

FIG. 3 depicts a functional block diagram of an example embodiment of a system for compressing an update to a data file.

FIG. 4 illustrates an example embodiment of a method, for encoding an update of a file from a first version to a second version via differential encoding.

FIG. 5 depicts a functional block diagram of another example embodiment of a system for compressing an update to a data file.

FIG. 6 illustrates another example embodiment of a method for encoding an update to a file from a first version to a second version via differential encoding.

FIG. 7 illustrates yet another example embodiment of a method for encoding an update to a file from a first version to a second version via differential encoding.

### DETAILED DESCRIPTION

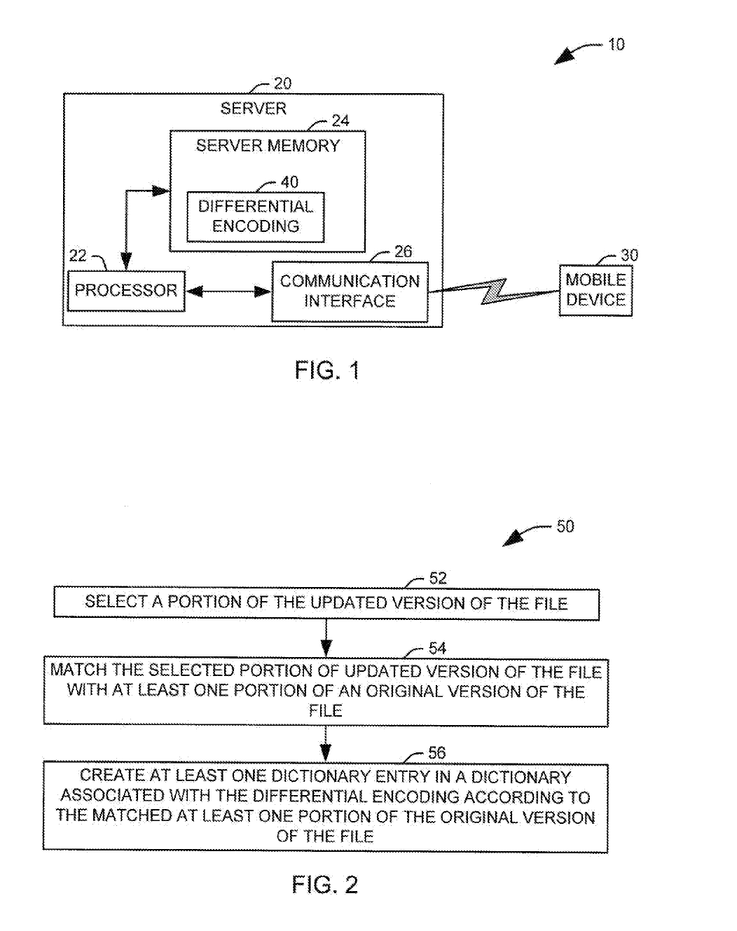

FIG. 1 illustrates an example of a mobile communications system 10. The system 10 includes at least one server 20, comprising at least a processor 22 and a server memory 24 and configured to communicate, via a communication interface 26, with at least one mobile device 30. It will be appreciated that the communication interface can comprise any appropriate means for passing information between the server 20 and the mobile device 30. In one example implementation, the communication interface 26 can comprise a wireless transceiver. The server memory 24 can include any appropriate standard storage devices associated with computer systems, such as one or more of semiconductor memory, magnetic and optical storage media.

The server memory 24 can comprise appropriate instructions for generating updates for at least one file associated with the mobile device 30. The server memory can include a data compression component that can be used to limit the size of the update, with the corresponding savings in bandwidth and transmission time. For instance, a differential encoding component 40 can be applied to an updated version of a file using an original version of the file as a reference for the encoding.

In the illustrated example, this differential encoding component 40 can be programmed to create compressed updates of large files within a limited amount of memory. As one example, differential encoding component 40 can utilize a sparse dictionary. As used herein, a dictionary is a data structure that is used to find corresponding sequences of bytes between the two file versions, and a sparse dictionary is a dictionary used for encoding a file in a differential encoding process in which less than every byte of a reference file used for the encoding is represented by a corresponding entry in the dictionary. As matches between the updated version of the file and the original version of the file are located, additional entries can be added to the sparse dictionary.

As another example, the differential encoding component 40 can divide each version of the file into discrete blocks and calculate a similarity metric between each block in the updated version of the file and each block in the original version of the file. It will be appreciated that the term “similarity metric” is used herein broadly to refer to either of a metric indicating a degree of similarity between two data sets or a metric indicating a degree of difference between the data sets. Each block in the updated version of the file can be matched with one or more blocks from the original version of the file and encoded using those blocks as a reference.

FIG. 2 illustrates an example method 50 for compressing a file via differential encoding. The method 50 utilizes a differential encoding process to produce an update, which represents an updated version of a file, using an original version of the file as a reference. The example method 50 provides an efficient method for encoding large files while reducing the memory demands of the encoding process.

At 52, a portion of the updated version of the file is selected. For example, a block of the updated version of the file can be read into memory (e.g., random access memory (RAM). The size of a given block can be either predetermined or determined by a set of logical rules.

At 54, the selected portion of the updated version of the file is matched with at least one portion of the original version of the file. In one example, the original version of the file can be similarly divided into blocks, and a similarity metric can be calculated for each of the blocks of the original version of the file and the selected portion of the updated version of the file. The similarity metric can be used to match the selected portion of the updated version of the file with a set of one or more most similar blocks from the original version of the file, For example, a given similarity metric can comprise a correlation measure, a distance measure (e.g., Euclidean, Manhattan, Mahalanobis or the like), or a similar measure for determining a similarity or difference between two data sets.

In another example, the original version of the file can be represented by an incomplete dictionary, referred to herein as a sparse dictionary. For example, instead of a dictionary hash representing each byte of the original version of the file, the sparse dictionary can represent every r^{th} byte of the original file, reducing the size of the dictionary by a factor of r (where r is a positive integer greater than one (r>1)). The selected portion of the updated version of the file can be matched to a portion of the original file that is represented by one of the dictionary hashes in the sparse dictionary as part of the encoding process. The matching can be done by employing a similarity metric, such as described herein.

At 56, at least one dictionary entry in a dictionary associated with the differential encoding is created according to the matched portions of the original version of the file. For instance, where the sparse dictionary is used, one or more dictionary entries can be added in the dictionary to represent portions of the original file near portions that that have been matched to the selected portion of the updated version of the file. By “near,” it is meant that the added one or more entries can represent portions of the original file that are proximate to the matched portions in a sequential listing of the file. For example, an entry that is near a matched entry can have a starting byte that is a predetermined number of bytes (e.g., one or more bytes) from the starting byte associated with the matched entry or a predetermined number of bytes from a last byte of the matched material.

For an example in which the original version of the file is divided into blocks, a complete dictionary can be generated for each of the one or more blocks that is determined to be most similar to the selected portion of the updated version of the file, and a differential encoding process can be performed for the selected portion using data from those similar blocks. It will be appreciated that the two example implementations are not mutually exclusive, and that the differential encoding on the selected portion of the updated portion of the file can utilize a sparse dictionary as described herein.

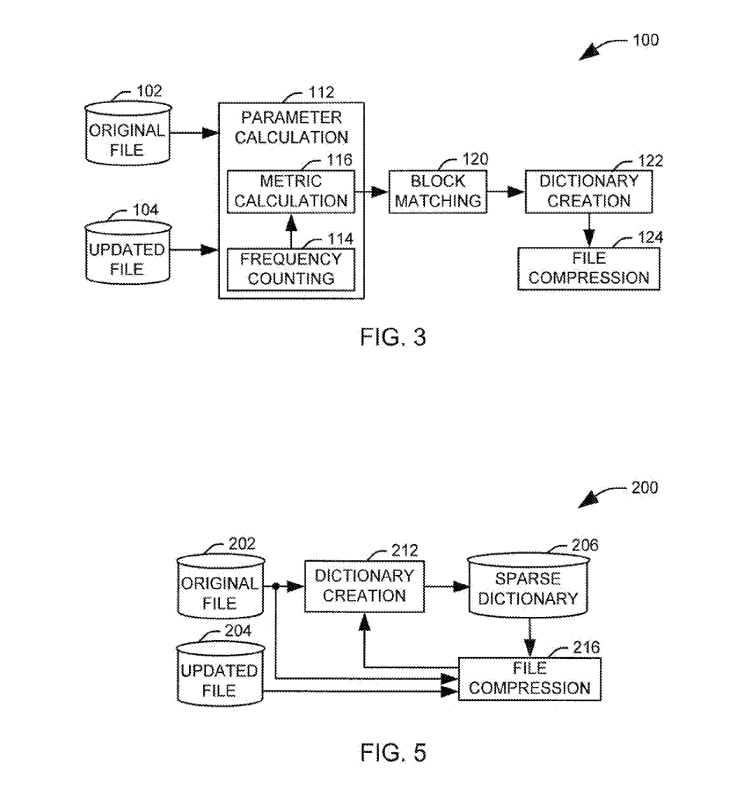

FIG, 3 is a functional block diagram illustrating a second example of a system 100 for compressing an update to a data file. In the example of FIG. 3, the various functional blocks can be stored as executable instructions on a non-transitory computer readable medium. It will be appreciated, however, that one or more of the illustrated functional blocks could be implemented as dedicated hardware or as a combination of software and dedicated hardware.

The system 100 is configured to compare an original version of a file 102 to an updated version of the file 104 to produce a compressed update for transmission to a mobile device via a differential encoding process. The system 100 is configured to analyze a large file as a plurality of blocks and compress each block separately to ease the memory demands of the dictionary creation process. The system identifies blocks in an original version of the file that resemble a given block in the updated version. Once appropriate blocks are identified, a differential encoding process can be performed for each block in the updated version.

As the system 100 is configured to provide a differential encoding in conditions in which memory may be limited, in one example implementation, the blocks formed from each file can be sized such that the necessary statistics, given the selected block size, can be stored in memory. It will be appreciated, however, that a predetermined size can be used for the blocks. Alternatively, blocks of variable size can be used, with the boundaries between blocks being selected according to natural features of the data. For example, the blocks can be selected to cover different sections of a file in a standard format, which sections can correspond to natural features. As another example, natural features of an executable program can correspond to any logical division of the code, such as methods, functions, modules, scripts, or any way blocks of code may be identifiable within a file or set of files.

A parameter calculation component 112 is configured to produce a plurality of metrics characterizing the similarity of the content of each of a plurality of blocks in the updated version of the file with each of a plurality of blocks comprising the original version of the file. To this end, the parameter calculation component 112 can include a histogram component 114 configured to determine a count of the occurrence of various byte strings, referred to herein as ‘frequency counts,’ within each block of the file and record the frequency counts to produce a representation of the content of the block. As one example, the counted byte strings can be adjacent byte pairs within the blocks. To ensure uniformity in size among blocks, the frequency counts for the various byte pairs can be normalized by dividing each of counts by a total number of byte pairs to produce a probability value for each byte pair.

Once the frequency counts have been determined, a metric calculation component 116 can calculate a similarity metric between each block of the updated version of the file and each of the blocks comprising the original version of the file from the determined frequency counts. As one example, the metric calculation component 116 can calculate the similarity metric for each pair of blocks as a greater of a Kullback-Leibler divergence from a first frequency count to a second frequency count and a Kullback-Leibler divergence from the second frequency count to the first frequency count.

The parameter calculation component 112 provides the calculated similarity metrics to a block matching component 120 configured to determine a set of most similar blocks from the original version of the file for each of the blocks comprising the updated version of the file. In one instance, the set of most similar blocks from the original version of the file is a proper subset of the plurality of blocks, such that less than all of the blocks are represented in the set. For example, the set of most similar blocks for each block of the updated version of the file can include a predetermined number of blocks from the original version of the file with which it has the largest similarity or smallest difference. Alternatively, all blocks from the original version of the file having a similarity value that meet a threshold value can be used. The threshold level can be fixed or variable depending on the calculated similarity metrics.

The matched blocks are provided to a dictionary creation component 122, which is configured to create a dictionary for each block of the updated version of the file that is suitable for performing a differential encoding of each respective block. For example, the dictionary for each block of the updated version of the file can include a plurality of dictionary hashes representing various portions of the set of matched blocks associated with the block of the updated version of the file. It will be appreciated that the represented portions can overlap, and, in one example, the dictionary will contain an entry for each byte of the set of matched blocks representing a multi-byte portion of the original version of the file beginning at the byte.

In one implementation, a single dictionary is formed representing all of the blocks in the set of most similar blocks for each block in the updated version of the file, Alternatively, a dictionary can be created for each block in a set of most similar blocks, allowing for future reuse of the dictionaries for blocks in each given set. It will be appreciated that these dictionaries can be created and used sequentially, such that the system can limit the dictionaries stored in memory at any given time to one or more dictionaries that are being used to compress a given block of the updated version of the file. Once the dictionary for a given block of the updated version of the file has been created, the block is compressed at a file compression component 124 using its associated set of most similar blocks as a reference.

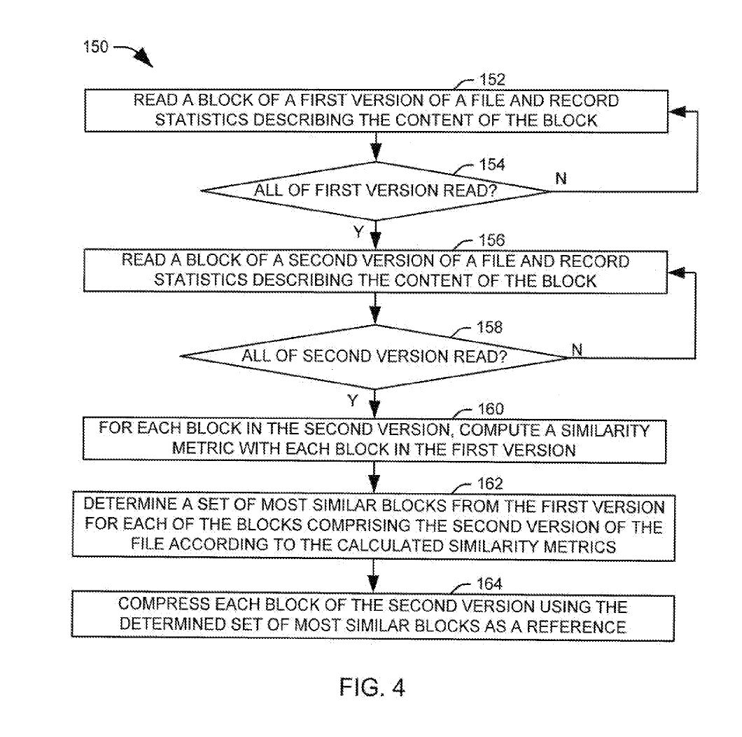

FIG. 4 illustrates an example method 150 for encoding an update to file from a first version to a second version via differential encoding. The example method 150 reads each of the first version of the file and the second version of the file in discrete blocks of a given size and calculates descriptive statistics representing the contents of each block. Using these descriptive statistics, the similarity of blocks of the first version of the file to blocks of the second version of the file can be determined, with each block of the second version of the file being compressed using one or more blocks from the first version of the file as a reference.

The method begins at 152, where a block of the first version of the file is read, and statistics describing the content of the block is recorded. It will be appreciated that the size of the blocks can be a predetermined constant value or it can be determined according to one or more characteristics of the file. For example, the size of the blocks can be determined as the ratio of the size of the first version of the file to a maximum number of statistics that can be stored in memory. In one example, the larger of the predetermined size and the ratio of the file size to the maximum number of statistics that can be stored in a designed region of memory. Alternatively, blocks of variable size can be used, with the boundaries between blocks being selected according to natural features of the data.

As a further example, the recorded statistics can include a frequency count of adjacent byte pairs in the block, stored in an appropriate format. In one example, each set of frequency counts is stored as a 256×256 matrix. To ensure uniformity among blocks, the matrix can be normalized by dividing each of the frequency count values in the matrix by a total number of byte pairs represented by the matrix to produce corresponding probability values for each byte pair.

At 154, it is determined if the entirety of the first version of the file has been read and processed at 152. If not, the method returns to 152 to read another block of the first version of the file. Otherwise, the method advances to 156, where a block of the second version of the file is read, and statistics describing the content of the block is recorded (e.g., the statistics are stored in memory). The recorded statistics for blocks of the second version of the file can be the same as the statistics used for the blocks comprising the first version of the file, namely, a frequency count of adjacent byte pairs in the block, which can be stored in an appropriate format. The frequency counts for the second version of the file can also be normalized, for example, by dividing the frequency count associated with each byte pair by a total number of byte pairs in the block, to account for differences in block sizes.

As with the first version of the file, the blocks can be of a standard size or a variable size. In one example, the second version of the file is divided into blocks of approximately the same size as the blocks comprising the first version of the file. It will be appreciated, however, that the two versions of the file can be of different sizes. Additionally or alternatively, natural features of the two versions can fall in different locations, such that, in some instances, there can be substantial deviation of the sizes of the blocks comprising the two versions of the file.

At 158, it is determined if the entirety of the second version of the file has been read. If not, the method returns to 156 to read another block of the first version of the file. Otherwise, the method advances to 160. At 160, a similarity metric, representing the similarity of the content of a given pair of blocks, is computed for each possible pair of a first block with a second block. The similarity metric for a given pair of the first and second blocks can be computed from the statistics recorded for each block, such as the frequency of various byte strings within the block. The byte strings can be of varying length, with larger byte strings providing better reliability for the similarity metric at the cost of computational complexity. In one example, the byte strings can have a length of two bytes, such that adjacent byte pairs are counted. For example, the similarity metric is a modification of the Kullback-Leibler divergence, in which the larger of a first divergence, between a first block and a second block of the pair, and a second divergence, between the second block and the first block, is used to represent the similarity of the pair, such that:

SD_{KL}(P||Q)=max[D_{KL}(P||Q),D_{KL}(Q||P)]; Eq. 1

where
P is a set of probabilities of the occurrence of byte pairs within the first block,
Q is a set of probabilities of he occurrence of byte pairs within the second block, and
D_{KL}(A||B) represents a Kullback-Leibler divergence do probability sets A and B such that:

$${D}_{KL} ( A \vert \vert B ) = {\sum }_{x = 1}^{N} A ( x ) log ( \frac{A ( x )}{B ( x )} ) ; \qquad Eq . 2$$

where
N is a total number of possible byte pairs (e.g., 65,536),
x is an index representing a given byte pair,
A(x) is a probability of the byte pair, x, occurring in the first block, and
B(x) is the probability of the byte pair, x, occurring in the second byte pair.

At 162, a set of most similar blocks from the first version of the file is determined for each of the blocks comprising the second version of the file according to the calculated similarity metrics. For example, the set of most similar blocks for each block of the second version of the file can include a predetermined number of blocks from the first version of the file with which it has the smallest modified Kullback-Leibler divergence. Alternatively, all blocks from the first version of the file having a Kullback-Leibler divergence with a block of the second version of the file that is less than a threshold value can be included in the set for that block. In one example, the two approaches can be combined, such that a number of blocks from the first version of the file having a Kullback-Leibler divergence with the block of the second version of the file that is less than a threshold value can be included up to a predetermined maximum set size.

At 164, each block of the second version of the file is compressed using its associated set of blocks from the first version of the file. For example, a dictionary can be constructed representing all of the blocks in the set of blocks, and a compression of the block from the second version of the file that is associated with the set of blocks can be performed with the dictionary representing the set of blocks. Alternatively, a separate dictionary can be constructed for each block in the set of blocks, allowing for reuse of the dictionaries between sets of blocks.

FIG. 5 is a functional block diagram illustrating a third example of a system 200 for compressing an update to a data file. In the illustrated example, the various functional blocks can be implemented as executable instructions on a non-transitory computer readable medium. It will be appreciated, however, that one or more of the illustrated functional blocks could be implemented as dedicated hardware or as a combination of software and dedicated hardware.

The system 200 is configured to compare an original version of a file 202 to an updated version of the file 204 to produce a compressed update, such as can be transmitted to a mobile device via a differential encoding process. In the illustrated example, the system 200 is configured to begin the process by creating a sparse dictionary 206. The sparse dictionary 206 represents selected portions of the original version of the file, instead of the complete contents of the original version of the file, to ease the memory demands of the dictionary creation process.

A dictionary creation component 212 populates the sparse dictionary 206 as the differential encoding process proceeds. For instance, new dictionary entries can be created as to be concentrated in regions of the dictionary 206 corresponding to locations where matches with the updated file have already been found.

By way of example, the dictionary creation component 212 can create a plurality of dictionary entries representing portions of the original version of the file. Each dictionary entry represents a starting byte and a plurality of bytes following the starting byte, and can include a hash mapping of the represented bytes. In the sparse dictionary 206, instead of including a dictionary entry for each possible staring byte, the dictionary is left incomplete. For example, the dictionary can include an entry for only each r starting bytes, where r is an integer greater than one, reducing the size of the dictionary by a factor of r.

A file compression component 216 can provide a differential encoding of the updated version of the file 204 using the original version of the file 202 as a reference. In one implementation of the illustrated system 200, when the file compression component 216 is not able to find a match in the sparse dictionary 206 for a given portion of the updated version of the file, additional entries can be added to the sparse dictionary 206 to increase the amount of the original version of the file represented. For instance, the entries can be added near portions of the original version of the file that have already been matched with the updated version of the file to increase the likelihood that the added entries will correspond to unmatched portions of the updated file.

In another example, the sparse dictionary 206 can be expanded after a first pass through the updated version of the file. In this example, the file compression component 216 attempts to match unmatched portions of the updated version of the file that are located close to a matched portion of the updated version of the file by selectively adding entries to the dictionary near the existing matches. For instance, the entries added in subsequent passes can represent locations near one or more portions of the original version of the file used as a reference for the nearby matched portion. It will be appreciated that the encoding and dictionary population can be repeated for multiple passes through the updated version of the file until a termination condition is achieved. By way of example, the termination condition can include a full encoding of the updated version, a predetermined number of passes, falling below a threshold number of matches in a given pass, or any other appropriate rationale for ending the encoding process.

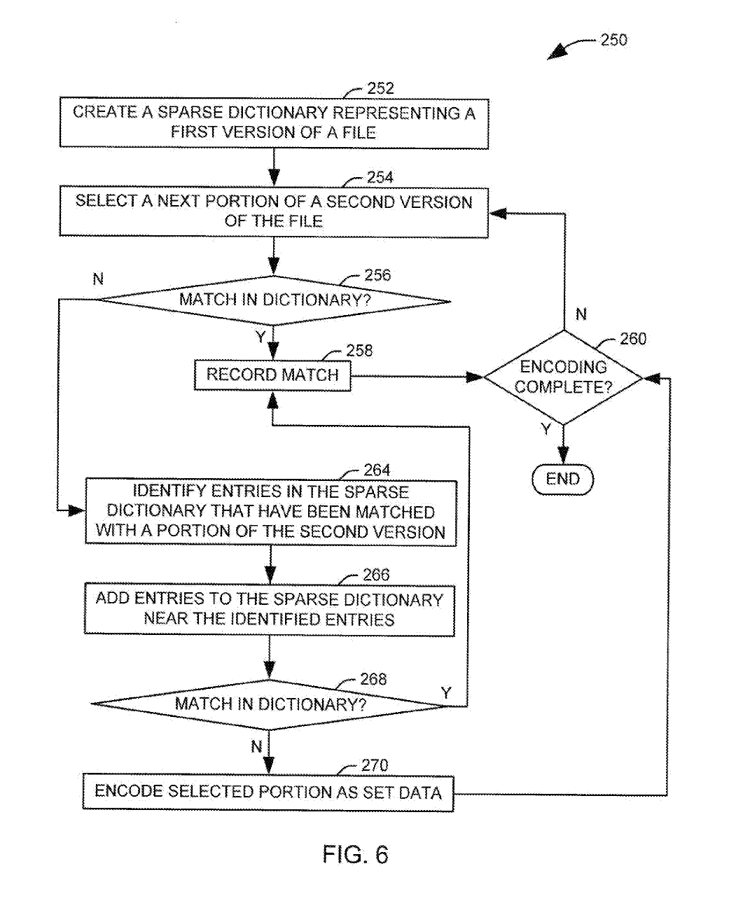

FIG. 6 illustrates one example implementation of a method 250 for encoding an update to a file from a first version to a second version via differential encoding. The illustrated method 250 utilizes a sparse dictionary for a first version of the file that represents only selected portions of its associated file. The sparse dictionary thus identifies regions of the first file that are similar to regions of the second version of the file. When a similar region has been identified, additional dictionary entries can be added near the identified region to facilitate compression of other portions of the second version of the file. For instance, the added one or more entries can represent portions of the original file that are proximate to the matched portions in a sequential listing of the file.

At 252, a sparse dictionary is created, representing at least a portion of the first version of the file. For example, the dictionary can contain regularly spaced entries. In one implementation, the dictionary entries are stored hash values representing a bit pattern (e.g., a byte string) of predetermined length. Since compression generally utilizes an entry for each byte of the file, placing entries at a predetermined spacing interval reduces the size of a dictionary by a factor equal to the length of that interval in bytes.

At 254, a next portion of the second version of the file is selected. At 256, it is determined if the portion of the second version of the file selected at 254 matches an entry in the sparse dictionary. If so (Y), the method advances to 258, where the match is recorded between the selected portion of the second version of the file and the bytes in the first version of the file represented by the matched dictionary entry. It is then determined, at 260, if the entire second version of the file has been encoded. If some portion of the second version of the file remains to be encoded (N), the method returns to 254 to select a next portion of the second version of the file. Otherwise (Y), the method terminates.

If the selected portion of the second version of the file does not match an entry in the dictionary (N), the method advances to 264, where one or more entries of the sparse dictionary that have been matched with portions of the second version of the file are identified. At 266, one or more entries are added to the dictionary near the identified entries to represent portions of the first version of the file near the portions of the first file represented by the identified entries. The new one or more entries result in an expanded, yet still sparse dictionary. Each new entry can include a dictionary hash representing an unmatched portion of the first version of the file. At 268, it is determined if the selected portion of the second version of the file matches an entry in the newly expanded dictionary. If so (Y), the method proceeds to 258, where the match is recorded between the selected portion of the second version of the file and the bytes in the first version of the file represented by the matched dictionary entry. If it is determined, at 268, that the selected portion of the second version of the file does not match an entry in the newly expanded dictionary (N), the method advances to 270. At 270, the selected portion of the second version of the file is encoded as literal bytes, and the method then returns to 260 to determine if the encoding is complete.

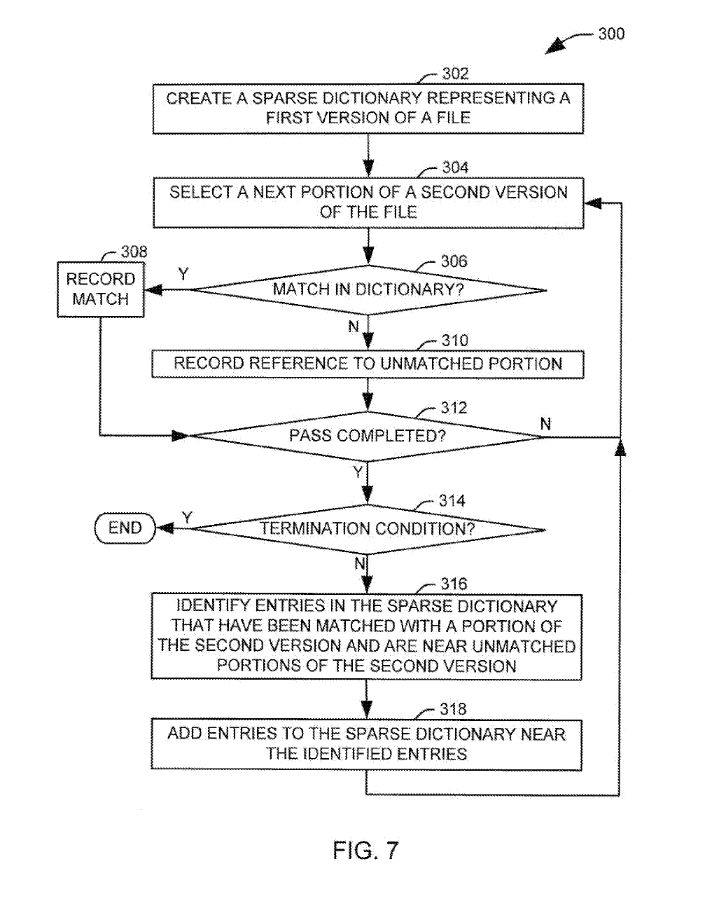

FIG. 7 illustrates another example implementation of a method 300 for encoding an update to a file from a first version to a second version via differential encoding. The illustrated method 300 initially utilizes a sparse dictionary, that is, a dictionary representing only selected portions of its associated file, for a first version of the file to identify regions of the first file that are similar to regions of the second version of the file. When a similar region has been identified, additional dictionary entries can be added around the identified region to facilitate compression of other portions of the second version of the file.

At 302, a sparse dictionary is created, representing at least a portion of the first version of the file. For example, the sparse dictionary can contain regularly spaced entries. In one implementation, each of the dictionary entries can be a stored hash value representing a pattern of predetermined length. Since differential encoding generally utilizes an entry for each byte of the file, placing entries at a predetermined interval reduces the size of a dictionary by a factor equal to the length of that interval in bytes. It will be understood that the entries in the dictionary and portions of the files being encoded can have different bit lengths than a byte.

At 304, a next portion of the second version of the file is selected. At 306, it is determined if the selected portion of the second version of the file matches an entry in the sparse dictionary. If so (Y), the method advances to 308, where the occurrence of the match is recorded between the selected portion of the second version of the file and the bytes in the first version of the file represented by the matched dictionary entry. If not (N), the method advances to 310, where a reference to the unmatched portion of the second portion of the file is recorded for later processing.

Regardless of the decision at 306, it is determined at 312 if a pass through the updated version of the file has been completed. For example, it can be determined if every currently unmatched portion of the second version of the file has been evaluated since the dictionary was last updated. If not (N), the method returns to 304 to select a next portion of the second version of the file. Otherwise (Y), the method advances to 314, where it is determined if a termination condition is present. By way of example, the termination condition can include a full encoding of the updated version, a predetermined number of passes, falling below a threshold number of matches in a given pass, or any other appropriate rationale for ending the encoding process. At 314, if a termination condition exists (Y), the method terminates.

If no termination condition is present (N), the method advances to 316, where previously matched portions of the updated version of the file that are near unmatched portions of the updated version are identified. At 318, addition entries are added to the sparse dictionary near one or more entries associated with the identified matched portions of the second version of the file. The method then returns to 304 to begin a new pass through the updated version of the file.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the scope of the appended claims.

What is claimed is:

1. A non-transitory computer readable medium, storing executable instructions configured to perform, upon execution at an associated processor, a method comprising differential encoding of an updated version of a file using an original version of the file, the method comprising:
selecting a portion of the updated version of the file;
matching the selected portion of the updated version of the file with at least one portion of the original version of the file, and
creating at least one dictionary entry in a dictionary associated with the differential encoding according to the matched at least one portion of the original version of the file.

2. The non-transitory computer readable medium of claim 1, wherein matching the selected portion of the updated version of the file with at least one portion of the original version of the file comprises:
determining a first set of descriptive statistics corresponding to a first block of a plurality of blocks comprising the original version of the file;
determining a second set of descriptive statistics associated with a second block of a plurality of blocks comprising the original version of the file;
determining a third set of descriptive statistics associated with the selected portion of the updated version of the file;
calculating a first similarity metric representing a similarity between the first block and the selected portion of the updated version of the file from at least the first set of descriptive statistics and the third set of descriptive statistics;
calculating a second similarity metric representing a similarity between the second block and the selected portion of the updated version of the file from at least the first set of descriptive statistics and the third set of descriptive statistics; and
matching the selected portion of the updated version of the file to a proper subset of at least one of the plurality of blocks comprising the original version of the file according to at least the first similarity metric and the second similarity metric.

3. The non-transitory computer readable medium of claim 2, wherein creating at least one dictionary entry further comprises generating a dictionary representing the proper subset of the at least one of the plurality of blocks.

4. The non-transitory computer readable medium of claim 2, wherein creating at least one dictionary entry further comprises generating a dictionary representing each of the proper subset of the at least one of the plurality of blocks.

5. The non-transitory computer readable medium of claim 2, the first similarity metric comprising a greater of a Kullback-Leibler divergence from the first set of descriptive statistics to the third set of descriptive statistics and a Kullback-Leibler divergence from the third set of descriptive statistics to the first set of descriptive statistics.

6. The non-transitory computer readable medium of claim 2, wherein the file is in a standard format, each of the plurality of blocks comprising the original version of the file being selected such that each block is associated with one of a plurality of different file sections within the standard format.

7. The non-transitory computer readable medium of claim 2, wherein determining the first set of descriptive statistics corresponding to a first block of a plurality of blocks comprising the original version of the file comprises determining a frequency count for each of a plurality of byte strings within the first block.

8. The non-transitory computer readable medium of claim 7, wherein determining the first set of descriptive statistics corresponding to a first block of a plurality of blocks further comprises dividing the frequency count for each of the plurality of byte strings within the first block by a total number of counted byte strings in the first block.

9. The non-transitory computer readable medium of claim 1, wherein matching the selected portion of the updated version of the file with at least one portion of the original version of the file comprises:
generating a sparse dictionary for the different encoding of the updated version of the file, the sparse dictionary having entries representing less than all of the bytes in the original version of the file;
comparing the selected portion of the updated version of the file to the sparse dictionary to determine if the selected portion of the updated version of the file matches an entry in the sparse dictionary; and
associating the selected portion of the updated version of the file to a portion of the original version of the file, corresponding to the matching entry from the sparse dictionary, if the comparison determines that the selected portion of the updated version of the file matches an entry in the sparse dictionary.

10. The non-transitory computer readable medium of claim 9, wherein creating at least one dictionary entry further comprises:
encoding the selected portion of the updated version of the file using the associated portion of the original version of the file; and
adding at least one other dictionary entry to the sparse dictionary near an existing dictionary entry corresponding to the determined at least one portion of the original version of the file.

11. The non-transitory computer readable medium of claim 9, wherein each portion of the updated version of the file is selected and compared to the sparse dictionary before the at least one dictionary entry is created.

12. The non-transitory computer readable medium of claim 9, wherein creating at least one dictionary entry comprises:
identifying a portion of the updated version of the file that the comparison has determined to match an entry within the sparse dictionary and is near another portion of the updated version of the file that has been determined not to match an entry of the sparse dictionary; and
adding at least one further dictionary entry to the sparse dictionary near the entry that corresponds to the identified portion of the updated version of the file.

13. A system configured to perform differential encoding of an updated version of a file using an original version of the file as a reference comprising:
a parameter calculation component configured to produce a plurality of metrics characterizing a similarity of content of a selected portion of the updated version of the file with each of a plurality of blocks comprising the original version of the file;
a block matching component configured to determine a set of most similar blocks from the original version of the file for the selected portion of the updated version of the file from the plurality of metrics; and
a dictionary generation component configured to produce at least one dictionary configured for use in the differential encoding, from the set of most similar blocks from the original version of the file; and
a file compression component configured to utilize the at least one dictionary to perform differential encoding on the selected portion of the updated version of the file using its associated set of most similar blocks as a reference from the original version of the file.

14. The system of claim 13, at least one of the plurality of blocks comprising the original version of the file being selected according to natural features within the original file.

15. A method for differential encoding of an updated version of a file using an original version of the file comprising:
generating a sparse dictionary for the different encoding of the updated version of the file, the sparse dictionary having entries representing less than all of the byte comprising the original version of the file;
selecting a portion of the updated version of the file;
comparing the selected portion of the updated version of the file to the sparse dictionary to determine if the selected portion matches an entry in the sparse dictionary;
encoding the selected portion of the updated version of the file using a portion of the original version of the file associated with the matching entry from the sparse dictionary as a reference if the selected portion of the updated version of the file matches an entry in the sparse dictionary; and
adding at least one dictionary entry to the sparse dictionary near the matching entry in the sparse dictionary.
